(19) United States
(12) Patent Application Publication
(10) Pub. No.: US 2004/0056006 A1
(43) Pub. Date: Mar. 25, 2004

(54) Welding method

(75) Inventors: Ian Anthony Jones, Cambridge (GB); Roger Jeremy Wise, Newmarket (GB)

Correspondence Address: Martin Novack, Esq., 16355 Vintage Oaks Lane, Delray Beach, FL, 33484, US

(73) Assignee: The Welding Institute

(21) Appl. No.: 10/666,264

(22) Filed: Sep. 19, 2003

Related U.S. Application Data
(63) Continuation of application No. 09/806,613, filed on Mar. 29, 2001.
Application No. 09/806,613 is a 371 of international application No. PCT/GB99/03241, filed on Sep. 30, 1999.

(30) Foreign Application Priority Data
Oct. 1, 1998 (GB) 9821375.4

(51) Int. Cl. B23K 26/00

(52) U.S. Cl. 219/121.64

(57) ABSTRACT

A method of forming a weld between workpieces (1, 2) over a joint region (3). The method comprises: exposing the joint region (3) to incident radiation (4) having a wavelength outside the visible range so as to cause melting of the surface of one or both workpieces at the joint region, and allowing the melted material to cool thereby welding the workpieces together. A radiation absorbing material is provided at the joint region (3) in one of the workpieces (1,2) or between the workpieces which has an absorption band matched to the wavelength of the incident radiation so as to absorb the incident radiation and generate heat for the melting process. The absorption band lies outside the visible range so that the material does not affect the appearance of the joint region (3) or the workpieces (1, 2) in visible light.

The present invention relates to a method of forming a weld between two workpieces, over a joint region.

Transmission laser welding is a technique which has been developed for welding together materials such as plastics. This is achieved by positioning two plastic members in contact, one of which is transparent, the other of which is opaque to visible light. The region of contact between the two plastic members is then exposed to a laser beam. The laser beam passes through the transparent plastic member and is absorbed by the second opaque plastic member. This causes the opaque plastic member to heat up causing the region of contact between the two plastic members to melt, thereby forming a weld. Examples are described in “Laser-transmission welding of PE-HD”, Kunstoffe 87 (1997) 3, pp 348-350; Puetz H et al, “Laser welding offers array of assembly advantages”, Modern Plastics International, September 1997; Haensch D et al, “Joining hard and soft plastics with a diode laser”, Kunstoffe 88 (1998) 2, pp 210-212; and Jones I A, “Transmission laser welding of plastics”, Bulletin of The Welding Institute, May/June 1998.

All these methods are limited by the need to provide at least one workpiece which is opaque to visible light.

In accordance with the present invention, we provide a method of forming a weld between workpieces over a joint region, the method comprising exposing the joint region to incident radiation having a wavelength outside the visible range so as to cause melting of the surface of one or both workpieces at the joint region, and allowing the melted material to cool thereby welding the workpieces together, the method further comprising providing a radiation absorbing material at the joint region in one of the workpieces or between the workpieces which has an absorption band matched to the wavelength of the incident radiation so as to absorb the incident radiation and generate heat for the melting process, the absorption band being substantially outside the visible range so that the material does not affect the appearance of the joint region or the workpieces in visible light.

Accordingly, we provide a method for welding workpieces so as to produce a visually transmissive weld. This is achieved by including visually transmissive material at the joint region which absorbs radiation outside the visible spectrum. The joint region is then exposed to radiation of this wavelength, causing the joint region to heat up. This in turn causes the workpieces to melt such that a weld is formed between the two workpieces. If the workpieces and the joint region are themselves transmissive to visible radiation, the weld is also at least translucent to the naked eye.

The workpieces may be opaque and have similar or dissimilar colours and/or be transparent or translucent to visible light.

In some cases, the material absorbent to the radiation is included in one of the workpieces.

In other cases, two workpieces may be welded together with the material being sandwiched between the two workpieces. This then enables workpieces which do not include a suitable radiation absorbing material to be welded together.

The radiation absorbing materials, which are typically in the form of additives, may comprise dyes or pigments while the use of an additive allows standard plastics and other materials to be readily modified to allow welding by the new method. Dyes are preferred to pigments because the particulate nature of pigments means that light scattering occurs and light absorption efficiency is reduced. In addition the low molar absorption coefficients of pigments means that higher concentrations have to be used to produce a given heating effect, and apart from the cost disadvantages, this can lead to undesirable changes in the physical properties of the host, including the appearance of unwanted colour. In the remainder of this specification, dyes will be referred to although the alternative of pigments may also be appropriate.

In some cases the radiation absorbing material may have some residual colour that is visible when viewed as thick sections or with high concentrations of the material present. The strongest absorption will always be in invisible regions, however.

An ideal near-infrared dye for laser welding of transparent plastics would have the following attributes:

A narrow, absorption band near 800 nm, (or longer wavelengths, depending on the laser used) with a high molar absorption coefficient.

Little if any absorption in the region 400-700 nm.

Good solubility in the host.

Good stability towards the incorporation method used.

Should not degrade to coloured by-products.

Examples of three dye types which can satisfy all of the above requirements are the cyanine dyes, the squarylium dyes, and the croconium dyes.

Each of the workpieces will typically be made of plastics material although these need not be the same. An example is PMMA perspex. The radiation absorbing material may be provided in just one of the workpieces or in an insert to be placed between the workpieces.

Near infrared absorber dyes have the properties of absorbing light in the region beyond 780 nm with high efficiency. That is, they have high extinction coefficients at one or many wavelengths in that spectral region. When this light is absorbed whether it be from a laser source or an incoherent light source, the molecules dissipate the absorbed energy principally as heat via vibronic relaxations, and this heat is localised to the dye molecules and to their immediate host environment. In the case where the host is a polymer (most thermoplastics and some highly crosslinked polymers as well), a melting occurs at the surface where the dye and polymer are. If a clear polymer (i.e., one that does not absorb NIR radiation but which may simultaneously be water white or coloured) is adjacent to this surface, the melting will cause a weld to occur.

Thus, in order to have the weld occur, the dye must be absent from the front plastic entity allowing the laser light to pass through it unabsorbed and must be localised at least at the surface of the other plastic entity or at the interface between the two plastic pieces. In this sense, the lamina of dye is essentially behaving as an optical focal element for the laser light, absorbing it very efficiently in an extremely thin layer and converting the absorbed light to heat in that same layer. The laser light as well as other wavelengths of light are otherwise effectively transmitted by the remainder of the ensemble which lies in front of this laminar surface as well as behind this surface (an exception to the latter is when the option is used in which one element to be welded has its bulk pervaded by the dye). The establishment of such a dye-laden laminar surface can be accomplished in several ways:

The dye can be incorporated into a thin film which can be placed at the interface of the plastic pieces to be welded. The film substrate can be the same polymer(s) being welded but may also be a different polymer. Dye concentrations of approximately 0.02% on a film weight basis are typically adequate but are a function of the particular dye used as well as the plastics being welded. A film thickness of approximately 25 μm is also typical. The advantage of using a film/tape containing the absorber dye is that the dye is needed in the film only where there is to be welding and its carrier is a solid allowing for ease of handling, storage, etc. Another advantage is that both plastic pieces can be of the same material and may notably be transparent plastic.

The dye can be introduced into the bulk of the polymer of the latter of the two polymer pieces (latter in terms of which one the laser light encounters). Only that dye at or very near the surface is active at absorbing the laser light since the dyes are highly efficient NIR absorbers. The light absorption results in the weld as before but without the use of tape/film. The advantage is that there is no extra step in the welding manufacturing having to do with application of tape, etc.

The surface of the latter plastic piece can be made, for instance, by having a dye laden film used as a mould insert in a moulding operation to generate the dye rich surface on the plastic piece.

The surface of one of the substrates to be moulded may be imparted a surface application of the dye by dip coating, dye infusion, painting, spraying, printing, dry burnishing, paste application, etc. This is a low cost alternative in terms of dye used and offers flexibility in that only selected areas can be treated.

The material to be welded can be coextruded with polymer containing the dye, but this can restrict the approach to certain applications able to make use of the extruded form.

A plastic piece can be overmoulded to provide a narrow strip, for example, to a selected area, but this encounters a higher moulding cost.

The radiation absorbing material could be exposed directly to the radiation and then the two pieces butted together (optionally under pressure) or more usually will be exposed through a workpiece. Typically, that workpiece will not include a radiation absorbing material so that heating is localised to the interface between the two workpieces.

Typically, the radiation having the predetermined wavelength is infrared radiation, for example with a wavelength of substantially 780 nm or more, typically up to 1500 nm. It will however be realised that any radiation outside the visible spectrum may be used providing a suitable radiation absorbing material is available, and, if appropriate, one side of the joint is transmissive to the radiation used.

A variety of conventional radiation sources may be used including both diode and Nd:YAG lasers. Focused infrared lamps could also be used.

Examples of methods according to the present invention will now be described with reference to the accompanying drawings, in which:—

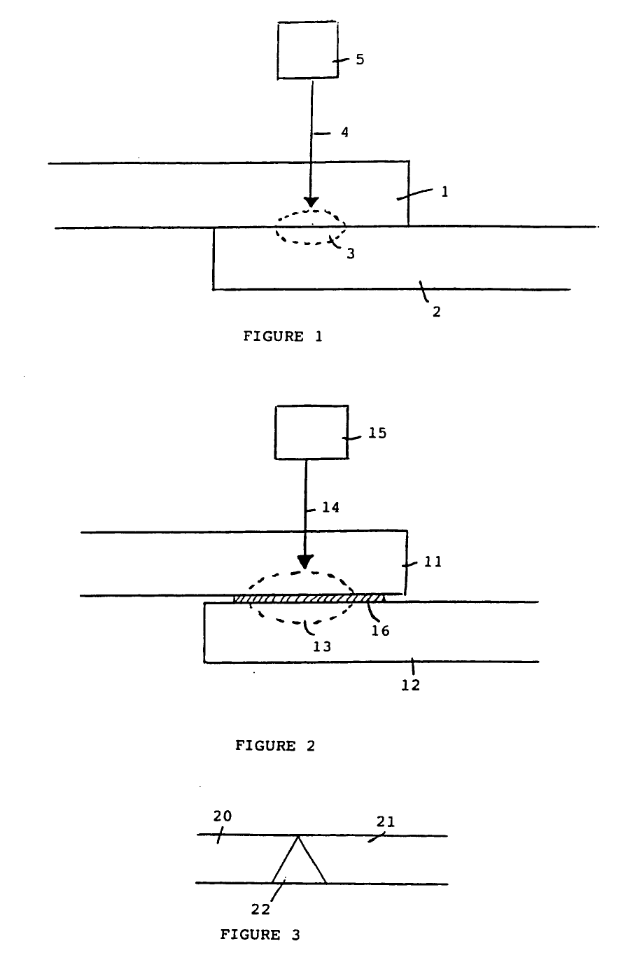

FIGS. 1 to 3 are schematic side views of three different welds.

FIG. 1 shows a first plastics workpiece 1 and a second plastics workpiece 2 positioned in overlapping contact so as to define a joint region indicated at 3. The joint is welded by exposing the joint region 3 to a beam of non-visible radiation 4 from a source such as a laser 5, an i.r. lamp or the like.

The first plastics workpiece 1 is transmissive to radiation from the radiation beam 4 and may or may not transmit visible light. In this respect, transmissive means that the plastics workpiece 1 absorbs less than a predetermined portion of the incident radiation. Accordingly, the plastics workpiece 1 may be transparent or translucent to radiation in the visible spectrum, or may reflect such radiation but typically will not be totally absorbent (ie. black). Thus, the plastics workpiece 1 will be either colourless, clear with a coloured tint, or coloured.

The plastics workpiece 2 also may or may not be transmissive to radiation in the visible spectrum. However, in contrast to the plastics workpiece 1, it is necessary for the plastics workpiece 2 to be able to absorb the radiation beam 4. Accordingly, an additive is added to the plastics workpiece 2, the additive being absorptive of the radiation beam wavelength and being transmissive to radiation in the visible spectrum. Because only the joint region 3 will be exposed to the radiation beam 4, the additive may be provided only in the part of the plastics workpiece 2 which is to form the joint region, or alternatively it may be provided throughout the entire plastics workpiece 2.

The radiation beam 4 has a wavelength outside the visible spectrum but in a range which will be absorbed by the additive. This is typically infrared radiation having a wavelength between 780-1500 nm. Accordingly, the laser 5 may be an Nd:YAG laser, or a diode laser.

When the joint region 3 is exposed to the radiation beam 4, the additive will absorb the radiation. This causes the additive to heat up melting the plastics workpieces 1,2 in the joint region 3, whereby on cooling the workpieces weld together. When the weld is formed, because the materials at the weld are transmissive to radiation in the visible spectrum, the weld itself will make little or no change to the visible appearance of the component. Welding occurs as a result of the heat generated giving melting of the plastic material up to a depth of typically 0.2 mm. Where compatible material is in good contact interdiffusion of molecules and hence welding will occur. The heat generation at the weld interface is controlled by the absorption coefficient of the dye layer, and the processing parameters. The main parameters are laser power, which is typically between 10W and 500W, the welding speed (typically 5-200 mm/sec) and the spot size of the laser beam (0.5-10 mm wide). Processing can also be carried out with a fixed laser array, which would irradiate the joint area for a defined time.

A second embodiment of the present invention is shown in FIG. 2. In FIG. 2, there is provided a first plastics workpiece 11 and a second plastics workpiece 12. There is also provided a thin film of weld material 16 which is positioned between the first plastics workpiece 11 and the second plastics workpiece 12, so as to define a joint region 13. In order to weld the first and second plastics workpieces 11,12, the joint region 13 is exposed to the beam of radiation 14, from a source 15 such as a laser or the like.

As in the first embodiment of the present invention, the first and second plastics workpieces 11,12 may or may not be transmissive to radiation in the visible spectrum. However, in contrast to the first embodiment, it is not necessary for the second plastics workpiece 12 to absorb the radiation from the radiation beam 14.

However, the weld film 16 whilst being transmissive to radiation in the visible spectrum is absorptive to radiation from the radiation beam 14. Thus, as in the first embodiment of the present invention, when the joint region 13 is exposed to the radiation beam 14, the weld material 16 absorbs heat causing heating of the surrounding joint region 3. Consequently the plastics workpieces 11,12 melt in the joint region 13 and on cooling form a weld. Again this is optically transmissive to radiation in the visible spectrum.

In its most basic form absorption in a translucent material follows an exponential link to thickness (ignoring the effects of reflection and scattering), i.e.

fraction transmitted=exp(−at)

where a is the absorption coefficient and t is the thickness of the workpiece. The absorption coefficients for the translucent plastics we have measured range from 0.02 mm⁻1 to 0.4 mm⁻¹ at 800-1100 nm wavelength. Thus a useful range is anything less than about 1 mm⁻¹ for a translucent plastic. In a process of the form shown in FIG. 2, the layer of dye had an absorption coefficient of about 5.4 mm⁻¹. Typically, therefore, the absorptive layer should have an absorption coefficient greater than about 3 mm⁻¹.

It will be realised that in either of the above examples, the plastics workpieces 1,2; 11,12 may be clamped together during the welding process to ensure the joint region is maintained in contact while the weld forms. Alternatively, the component with the absorptive material may be irradiated first and then the workpieces brought together.

A further weld configuration is shown in FIG. 3 in which a pair of plastics workpieces 20,21 are welded together using a transparent insert 22 which is absorbent to laser light. The workpieces 20,21 in this case are not absorbent to laser light.

It will be appreciated that many further variations are possible such as butt welds and the like.

Typical absorbent additives can be selected from chemical groups such as metal phthalocyanine dyes, metalated azo dyes and metalated indoaniline dyes. Table 1 below provides a set of examples of matched sources and materials:

TABLE 1

| | Wavelength | | Wavelength |
|---|---|---|---|
| Light source | range nm | Absorbing medium | range nm |
| Infrared lamp | 700-2500 | Gentex dye A195 | 780-1100 |
| | | Gentex dye A101 | 750-1100 |
| Nd: YAG laser | 1064 | Gentex dye A195 | 780-1100 |
| Diode laser, | 940-980 | Gentex dye A195 | 780-1100 |
| GaAs | | | |
| Diode laser, | 790-860 | Gentex dye A187 | 821-858 |
| InGaAs | | | |

### EXAMPLES

PMMA sheet welding: Two clear sheets of polymethylmethacrylate approximately 3 mm thick have been lap welded using the ClearWeld™ process with a. Nd:YAG laser. A 10-15 μm MMA film containing typically 0.01-0.1 wt % infrared absorbing dye was placed at the interface. The two pieces were clamped together and welded with an applied power of 100W at speeds in the range 0.1-11.0 m/min. The laser beam used was approximately 6 mm in diameter and the film was 5 mm wide. Tensile tests on these samples gave failure in the parent material adjacent to the weld with loads in the order of 50N/mm. The weld obtained had very little residual colour and was as clear or clearer than the parent PMMA.

Polyurethane coated fabric welding: Two white translucent pieces of polyurethane coated fabric approximately 0.15 mm thick have been lap welded using the ClearWeld™ process. The infrared absorbing dye was applied from solution in acetone to the region to be welded between the lapped pieces. Typically 0.001-0.1 μg/mm² of dye were applied to the fabric. The two pieces were clamped together and welded with an applied power of 100W at speeds in the range 0.5-2.0 m/min. The laser beam used was approximately 6 mm in diameter. The weld obtained had very little residual colour.

PA/PTFE laminate fabric welding: Two coloured opaque pieces of polyamide/polytetrafluoroethylene laminated fabric approximately 0.15 mm thick have been lap welded using the ClearWeld™ process. The infrared absorbing dye was applied from solution in acetone to the region to be welded between the lapped pieces. Typically 0.001-0.1 μg/mm² of dye were applied to the fabric. The two pieces were clamped together and welded with an applied power of 100W at speeds in the range 0.1-11.0 m/min. The laser beam used was approximately 6 mm in diameter. The weld region obtained had no apparent residual colour apart from that of the original fabric.

The welding technique has also been used for welding nylon based fabrics (laser stitching/sewing/seam-sealing/etc.) and thin films (PE, PEEK). In these cases the dye was dissolved in a suitable solvent and painted over the joint region with resultant deposition of dye both at the surface and infusion of dye very slightly into the substrate. It was allowed to dry prior to welding. Clearly, use of polymeric substrates such as polyester, polycarbonate, polystyrene, polysilicones, etc. either alone or in textile or other blends and numerous thermoplastic films are obvious extensions of this example. It should be noted that while maximum dye utility is attained when the dye is truly dissolved in the substrate (film or bulk or other carrier), suspensions of dye applied in these modes are also efficient for the welding applications described above.

1. A method of forming a weld between workpieces over a joint region, the method comprising:
exposing the joint region to incident radiation having a wavelength outside the visible range so as to cause melting of the surface of one or both workpieces at the joint region, and allowing the melted material to cool thereby welding the workpieces together, the method further comprising providing a radiation absorbing material at the joint region in one of the workpieces or between the workpieces which has an absorption band matched to the wavelength of the incident radiation so as to absorb the incident radiation and generate heat for the melting process, the absorption band being substantially outside the visible range so that the material does not affect the appearance of the joint region or the workpieces in visible light.

2. A method according to claim 1, wherein the radiation absorbing material is sandwiched between two workpieces.

3. A method according to claim 1, wherein the radiation absorbing material is provided in at least one of the workpieces.

4. A method according to claim 1, wherein the radiation absorbing material is provided on the substrate by moulding the substrate in a mould with an insert formed by or including the radiation absorbent material.

5. A method according to claim 1, wherein the radiation absorbent material is provided as a coating on the substrate.

6. A method according to claim 1, wherein the radiation absorbent material is provided by coextruding the material with the substrate.

7. A method according to any of the preceding claims, wherein the radiation absorbing material is exposed to radiation prior to positioning the workpieces together.

8. A method according to any of the preceding claims, wherein the radiation absorbing material is exposed to radiation through one of the workpieces.

9. A method according to any of the preceding claims, wherein the workpieces are made of plastics.

10. A method according to any of the preceding claims, wherein the radiation absorbing material is a radiation absorbing dye.

11. A method according to any of the preceding claims, wherein the lower limit of the absorption band is above 700 nm.

12. A method according to claim 11, wherein the absorption band defines the range 780-1100 nm.

13. A method according to any of claims 1 to 11, wherein the absorption band defines the range 820-860 nm.

14. A method according to any of claims 1 to 11, wherein the absorption band lies in the infrared range.

15. A method according to any of the preceding claims, wherein the absorption band does not include the range 400-700 nm.

16. A method according to any of the preceding claims, wherein the radiation is in the infrared range.

17. A method according to any of the preceding claims, wherein the wavelength of the incident radiation lies in the range 700-2500 nm.

18. A method according to claim 17, wherein the wavelength of the incident radiation lies in the range 790-860 nm.

19. A method according to claim 17, wherein the wavelength of the incident radiation lies in the range 940-980 nm.

20. A method according to any of the preceding claims, wherein the radiation is a laser beam.

21. A pair of workpieces which have been welded by a method according to any of the preceding claims.
